(19) United States
(12) Patent Application Publication
(10) Pub. No.: US 2002/0009215 A1
(43) Pub. Date: Jan. 24, 2002

(54) Automated method and system for the segmentation of lung regions in computed tomography scans

(75) Inventors: Samuel G. Armato III, Downers Grove, IL (US); Heber MacMahon, Chicago, IL (US); Maryellen L. Giger, Elmhurst, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: ARCH DEVELOPMENT CORPORATION, Chicago, IL (US)

(21) Appl. No.: 09/760,854

(22) Filed: Jan. 17, 2001

Related U.S. Application Data
(60) Provisional application No. 60/176,297, filed on Jan. 18, 2000.

(51) Int. Cl. G06K 9/00

(52) U.S. Cl. 382/131

(57) ABSTRACT

Automated Method and System for the Segmentation of Lung Regions in Computed Tomography Scans A method and system for the automated segmentation of the lung regions in thoracic CT scans includes construction of a cumulative gray level profile from pixels along the diagonal of each CT section image. The shape of this profile is used to identify a gray level threshold that is used to create a binary image. A contour detection algorithm generates a segmented thorax region. The trachea and main bronchi are segmented and eliminated from the segmented thorax region to prevent subsequent inclusion within the segmented lung regions. A gray level histogram is constructed to identify a second gray level threshold, which is applied to the segmented thorax region to create a binary image. If the two lungs regions are “fused,” the anterior junction is then delineated and turned “off” in the binary image to separate the two lungs. The geometric properties of “holes” within the binary image are analyzed to identify holes caused by the diaphragm. Pixels within such holes are specifically excluded from the segmented lung regions. A contour detection algorithm is used to identify the outer margins of the largest “on” regions in the binary image (excluding pixels identified as diaphragm) to define the segmented lung regions. The segmented lung regions are modified by a rolling ball technique designed to incorporate pixels that may have been erroneously excluded by initial gray level thresholding. A second diaphragm analysis is performed to prevent the rolling ball technique from incorrectly including pixels that belong to the diaphragm.

### CROSS-REFERENCE TO PROVISIONAL APPLICATION

This application claims the benefit of and priority to U.S. Provisional Application Ser. No. 60/176,297, filed Jan. 18, 2000.

### STATEMENT REGARDING FEDERALLY SPONSORED RESEARCH

The U.S. Government has a paid-up license in this invention and the rights in limited circumstances to require the patent owner to license others on reasonable terms as provided for by the terms of grant numbers CA48985, CA62625, and CA64370 awarded by USPHS.

### BACKGROUND OF THE INVENTION

1. Field of the Invention

The invention relates generally to a method and system for the computerized, fully-automated delineation of the lung regions in thoracic computed tomography (CT) images. Novel developments and implementations include techniques for elimination of the patient table from the segmented thoracic region, segmentation of the trachea and main bronchi to prevent their inclusion within the segmented lung regions, a two- and three-dimensional rolling ball algorithm to further refine the segmented lung regions, separation of the two lungs at the anterior junction line, and identification of the diaphragm to prevent its inclusion within the segmented lung regions.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,740,268; 5,790,690; 5,832,103; 5,873,824; 5,881,124; 5,931,780; 5,974,165; 5,982,915; 5,984,870; 5,987,345; and 6,011,862; as well as U.S. pat. applications 08/173,935; 08/398,307 (PCT Publication WO 96/27846); 08/536,149; 08/562,087; 08/900,188; 08/900,189; 08/900,191; 08/900,361; 08/979,623; 08/979,639; 08/982,282; 09/027,468; 09/027,685; 09/028,518; 09/053,798; 09/092,004; 09/121,719; 09/131,162; 09/141,535; 09/156,413; 09/298,852; and 09/471,088; PCT patent applications PCT/US99/24007; PCT/US99/25998; and U.S. provisional patent applications 60/160,790 and 60/176,304; all of which are incorporated herein by reference.

The present invention includes the use of various technologies referenced and described in the above-noted U.S. Patents and Applications, as well as described in the references identified in the appended APPENDIX and cross-referenced throughout the specification by reference to the corresponding number, in brackets, of the respective references listed in the APPENDIX, the entire contents of which, including the related patents and applications listed above and the references listed in the APPENDIX, are incorporated herein by reference.

2. Discussion of the Background

Helical computed tomography (CT) of the thorax is widely used to evaluate numerous lung diseases, including lung nodules, emphysema, and pulmonary embolism [1]. The recent availability of multi-slice CT scanners promises to expand further the role of CT in the diagnostic imaging arena. The increasing volume of thoracic CT studies and the concomitant burgeoning of image data these studies generate have prompted many investigators to develop computer-aided diagnostic (CAD) methods to assist radiologists in evaluating CT images [2-12]. To provide radiologists with useful and reliable information, most such CAD methods will require accurate identification of the lung boundaries within the images, a preprocessing step known as “lung segmentation.”

The requirement for accurate lung segmentation is two-fold. First, the pathologies that continue to motivate development of the aforementioned CAD schemes are predominantly located within or impact the lungs. Consequently, these CAD schemes are designed to accommodate the anticipated appearance of the lung regions in CT images. Moreover, spatially limiting further processing to the lungs greatly reduces computation time, since the lungs occupy a fraction of the total volume of data acquired during a CT scan. Second, lung segmentation must be complete since abnormalities such as lung nodules may exist at the extreme periphery of the lungs. If the entire lung is not segmented, such abnormalities will be lost to subsequent analyses. Moreover, quantitative assessment of lung volume for the evaluation of, for example, emphysema, will be compromised by erroneous lung segmentation.

Aside for its application as a preprocessing step for CAD methods, automated lung segmentation may be useful for image data visualization. The three-dimensional display of CT image data is an area of rapid development with a number of well documented clinical applications [13]. Initial lung segmentation would be required in a situation where, for example, a volume-rendered version of the lung parenchyma is desired as an aid to the radiologist's diagnostic task.

Some form of automated lung segmentation serves as a necessary preprocessing step for various CAD schemes [2,3,5,14-26]. However, there is a need to improve and refine known techniques for automated lung segmentation.

### SUMMARY OF THE INVENTION

Accordingly, an object of this invention is to provide an improved method and system for segmenting the lung regions in thoracic CT images.

It is another object of this invention to provide an automated method and system for segmenting the thorax region and eliminating the patient table from thoracic CT images.

It is a further object of this invention to provide an automated method and system for delineating the trachea and main bronchi within the segmented thorax to prevent these structures from erroneously contributing to the segmented lung regions.

It is yet another object of this invention to provide an automated method and system for delineating the anterior junction line to prevent the merging of left and right lungs as a single segmented lung region.

It is a still further object of this invention to provide an automated method and system for refining the segmented lung regions through a two- and three-dimensional rolling ball algorithm to ensure proper inclusion of pixels along the peripheral and mediastinal aspects of the lungs.

It is still yet a further object of this invention to provide an automated method and system for identifying the diaphragm region within the thorax to prevent the erroneous inclusion of the diaphragm within the segmented lung regions.

These and other objects are achieved according to the invention by providing a new and improved automated method, storage medium storing a program for performing the steps of the method, and system in which segmentation of lung regions within thoracic images is performed. The method, on which the system is based, includes the steps of acquiring image data representative of a cross-sectional thoracic image; generating initial lung contours to segment the lung regions in the cross-sectional thoracic image; identifying within the lung region at least one portion corresponding to the diaphragm; and excluding from the lung regions the at least one portion corresponding to the diaphragm.

Preferably the step of identifying includes identifying holes within the lung regions; determining, for each hole, a geometric feature; comparing the geometric feature of each hole with a threshold; and determining, for each hole, whether the hole corresponds to the diaphragm based on the comparison of the geometric feature to the threshold; and the step of excluding step includes excluding from the lung regions the holes corresponding to the diaphragm.

The method also includes identifying an anterior junction line; extracting from the lung regions pixels along the anterior junction line to separate the lung regions; identifying within the lung regions portions corresponding to the trachea and main stem bronchi; excluding from the lung regions the portions corresponding to the trachea and the main stem bronchi; refining the lung contours by applying a rolling ball filter to the lung contours to identify indentations along the lung contours; determining, for each indentation identified by the rolling ball filter, whether the indentation corresponds to the diaphragm; and preventing the rolling ball filter from including within the segmented lung regions the indentations corresponding to the diaphragm. Preferably the rolling ball filter is a three-dimensional rolling ball filter applied to the lung contours in the cross-sectional thoracic image and to other lung contours in other cross-sectional thoracic images.

Specific application is given for the delineation of the lung regions in standard helical CT scans for such computerized detection schemes such as lung nodule detection, emphysema detection, and pulmonary embolism detection. For example, all or portions of the segmentation scheme of the present invention may be applied in the three-dimensional rendering of lung regions and/or in the detection of lung nodules as described in U.S. provisional patent application Ser. No. 60/176,304. However, the described methods are also valid for images acquired by conventional CT, high resolution CT, multi-slice CT, and low-dose helical CT.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a flowchart illustrating a method for the automated segmentation of the lung regions in thoracic CT images;

FIG. 2A is an image illustrating the selection of a gray level threshold for thorax segmentation based on a cumulative gray level histogram obtained from pixels along a diagonal in the image;

FIG. 2B is the cumulative gray level histogram obtained from the pixels along the diagonal line in the image of FIG. 2A;

FIGS. 3A and 3B depict the appearance of the segmented thorax region prior to, and subsequent to, respectively, the elimination of portions of the patient table that might be “connected” to the thorax region after initial segmentation;

FIGS. 4A and 4B are flowcharts illustrating a method for segmentation of the trachea and the main stem bronchi;

FIGS. 5A and 5B are images demonstrating the results of trachea and main bronchi segmentation, respectively, within the segmented thorax regions;

FIG. 6A is a typical gray level histogram constructed from pixels within the segmented thorax region;

FIG. 6B is an image illustrating the results of initial lung segmentation;

FIG. 7 is a flowchart illustrating a method for separating the right and left lungs merged at the anterior junction line;

FIG. 8A is an image of the anterior junction line and an identified cleft point;

FIG. 8B is the image of FIG. 8A with the pixels eliminated along the delineated anterior junction line;

FIG. 9 is an image depicting the exclusion of dense structures such as juxta-pleural nodules and hilar vessels from the initial lung segmentation contours;

FIGS. 10A and 10B are schematic illustrations demonstrating the two-dimensional rolling ball algorithm applied to the external aspect of the initial lung segmentation contours to identify and appropriately rectify erroneous indentations in the contours;

FIGS. 11 A and 11B are images of segmented lung regions before and after, respectively, application of the rolling ball algorithm;

FIGS. 12A is a lung region binary image with a large, circular hole (identified with an arrow) caused by the diaphragm;

FIG. 12B is a lung region image demonstrating how the rolling ball algorithm may incorrectly include an indentation caused by the diaphragm within the segmented lung region;

FIGS. 13A and 13B are flowcharts illustrating two methods for identifying pixels that belong to the diaphragm and excluding such pixels from the segmented lung regions;

FIG. 14 is a block diagram illustrating a system for implementing the inventive method for segmenting lung regions in thoracic CT images; and

FIG. 15 is a schematic illustration of a general purpose computer system 1500 programmed according to the teachings of the present application.

### DETAILED DESCRIPTION OF THE PREFERRED EMBODIMENTS

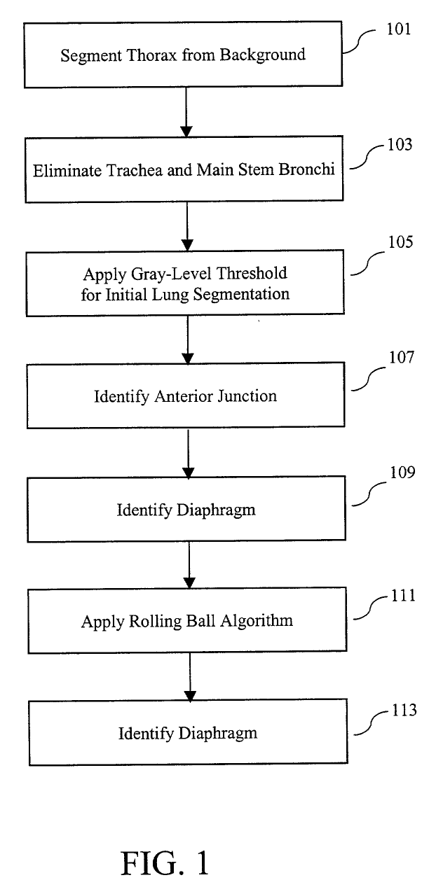

Referring now to the drawings, and more particularly to FIG. 1 thereof, a flowchart of the automated method for the segmentation of the lung regions in thoracic CT scans is shown. The overall scheme includes an initial acquisition of CT image data. A database of 17 helical thoracic CT cases (493 individual section images) was used to develop this method and evaluate the performance of various algorithms. The CT section images in the database were 512 by 512 pixels.

In step 101 the thorax is segmented from the background image data. Specifically, a cumulative gray level profile is constructed from pixels along the diagonal of each CT section image, and the shape of this profile is used to identify a gray level threshold. The gray level threshold is applied to the image so that the brightest pixels in the image remain “on” in the binary image that is created. A contour-detection algorithm is used to identify the outer margin of the largest “on” region in the binary image, and the set of all image pixels that lie within this contour is considered the segmented thorax region.

In step 103 trachea and main bronchi are segmented in all sections in which they appear. Pixels identified as belonging to the trachea or main bronchi are effectively eliminated from the segmented thorax region to prevent subsequent inclusion within the segmented lung regions.

Initial lung segmentation is performed in step 105. A gray level histogram is constructed from the remaining pixels in the segmented thorax region, and the broad minimum between the peaks of this typically bimodal histogram is used to identify a second gray level threshold for the initial lung segmentation. The gray level threshold is applied to the segmented thorax region so that the darkest pixels in the segmented thorax region remain “on” in the binary image that is created.

In step 107 the anterior junction is identified if the segmented lungs are fused together. The presence of a single large “on” region in the binary image is used as a flag to indicate that the two lungs regions are “fused” at the anterior junction. With the presence of an anterior junction line so established, the anterior junction line is delineated and pixels surrounding it are turned “off” in the binary image to separate into two distinct lung regions what had been erroneously identified by initial gray level thresholding as a single segmented lung region. In step 109 the diaphragm is identified. The geometric properties of “holes” within the binary image caused by regions of “off” pixels completely contained within larger “on” regions are analyzed to identify holes caused by the diaphragm. Pixels within such holes are specifically excluded from the segmented lung regions. A contour detection algorithm is used to identify the outer margins of the largest “on” regions in the binary image, and the set of all image pixels that lie within these contours (excluding pixels identified as diaphragm) is considered the segmented lung regions. In step 111 the segmented lung regions are modified by a rolling ball technique that effectively rolls a series of ball filters along the exterior aspect of the lung segmentation contours to incorporate pixels that may have been erroneously excluded due to initial gray level thresholding. In step 113 the diaphragm is identified a second time in a second diaphragm analysis to prevent the rolling ball technique from incorrectly including pixels that belong to the diaphragm.

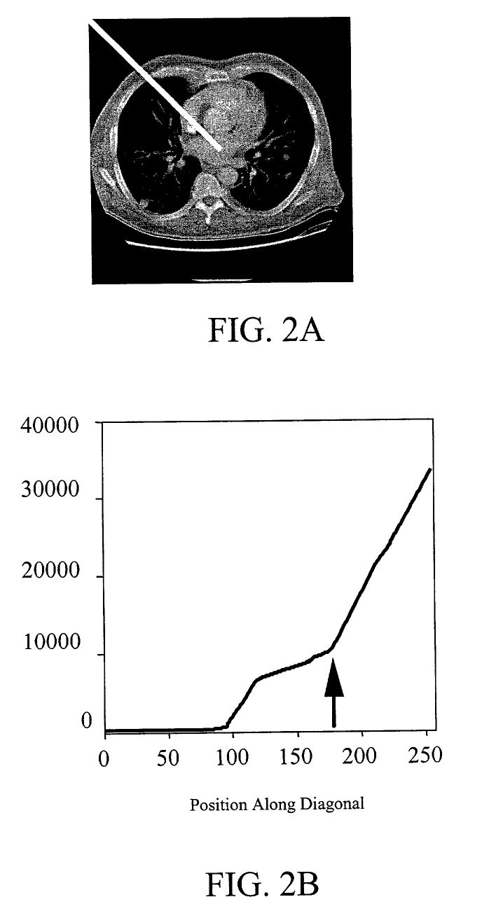

As visualized on a CT section image, the lung regions are represented by dark (i.e., low attenuation or low CT number) regions completely surrounded by a bright (i.e., high attenuation or high CT number) region, which, in turn, is completely surrounded by a dark region (the air outside the patient). Lung segmentation proceeds by first segmenting the thorax (i.e., the outer margin of the patent's body) in step 101 to eliminate from further consideration pixels representing air outside the patient. To achieve thorax segmentation, a cumulative gray level profile is constructed from the values of pixels that lie along the diagonal that extends from a comer of the image to the image center, as shown in FIG. 2A. The shape of this profile is analyzed to identify a single gray level as a threshold value [3], designated by an arrow in the gray level histogram of FIG. 2B. A binary image is created by thresholding the section image such that a pixel is turned “on” in the binary image if the value of the corresponding pixel in the section image has a value greater than the gray level threshold; all other pixels remain “off” in the binary image. An eight-point contour detection scheme [27] is used to construct a contour surrounding the outermost boundary of the largest “on” region in the binary image (i.e., the thorax). The set of pixels in the section image that lie within this contour defines the segmented thorax region and is used to create a thorax segmentation image such that pixels within the segmented thorax region maintain their original value, while pixels not included within the segmented thorax region are assigned a value of 0.

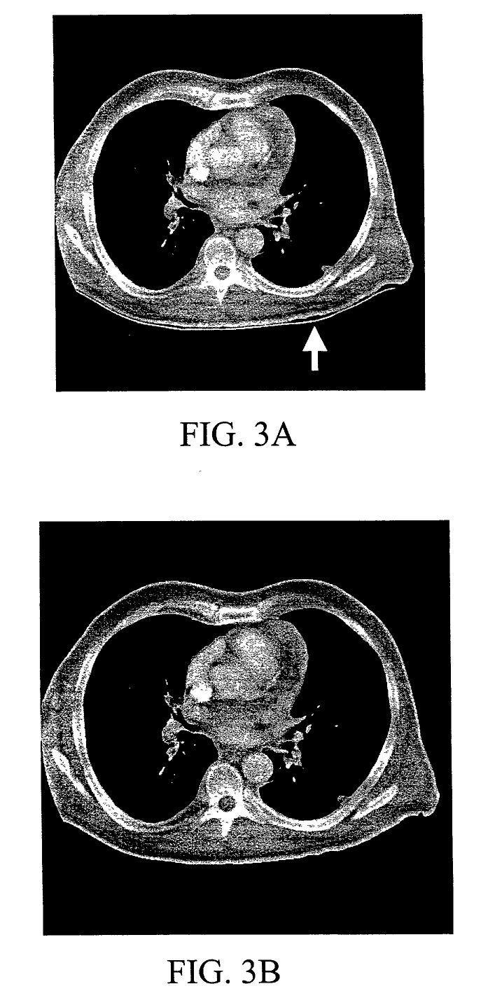

The segmented thorax region defined in this manner tends to include portions of the table on which the patient lies during the CT examination. The arrow in FIG. 3A points to a portion of the table in the image. To eliminate these pixels that represent structures external to the patient, each column in the thorax segmentation image is analyzed beginning at the bottom of the image (i.e., the posterior aspect). Pixels in a particular column are scanned until the first non-zero pixel is encountered (i.e., the first pixel within the segmented lung region). Subsequent pixels are examined to identify a reduction in gray level followed by an increase in gray level. Such a trend is assumed to represent air between portion of the table and the patient's body. The pixel associated with the point of maximum contrast as gray level subsequently increases is identified as the posterior margin point. The set of posterior margin points obtained for all image columns is smoothed to form a continuous margin line, and pixels that lie posterior to this margin line are eliminated from the segmented thorax region (i.e., assigned a gray level value of 0), as shown in FIG. 3B.

Initial lung segmentation based on gray level thresholding tends to include the trachea and main bronchi within the segmented lung regions. To ensure that these structures do not contribute to the segmented lung regions during the initial lung segmentation step, the trachea and main bronchi are segmented and eliminated from the segmented thorax region in step 103.

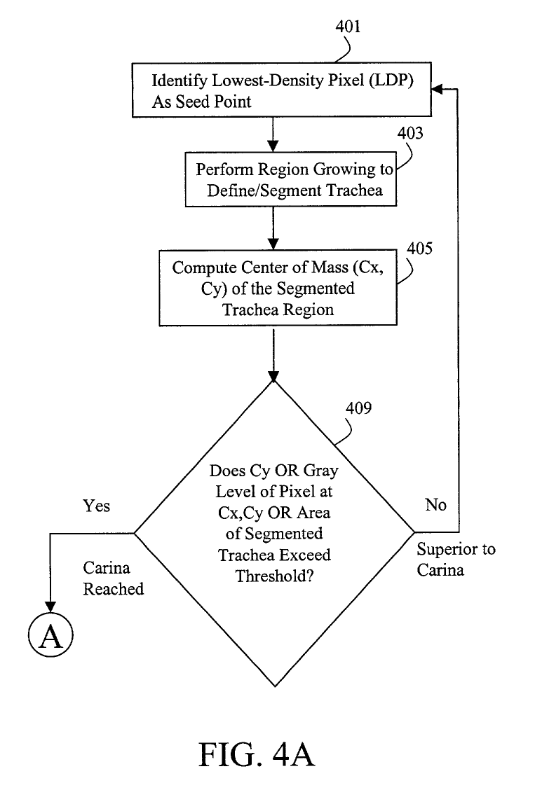

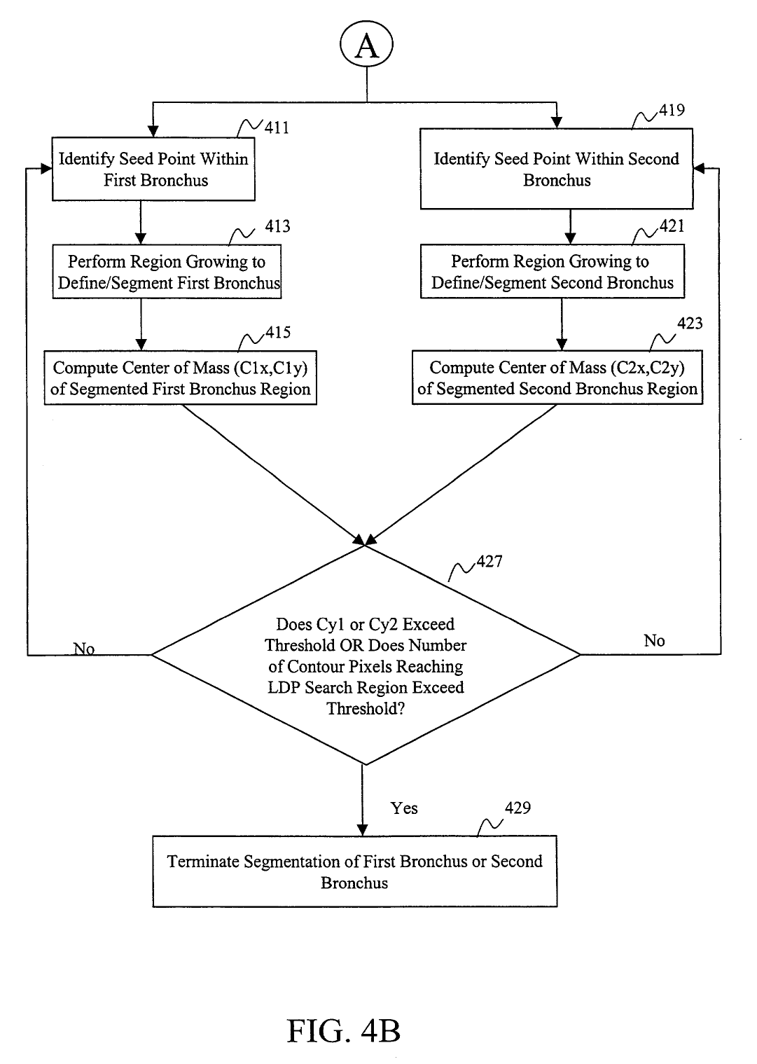

FIGS. 4A and 4B are flowcharts for explaining how the trachea and main stem bronchi are eliminated from the images. Referring to FIG. 4A, in step 401 a seed point for trachea segmentation is automatically identified in the central region in the first (i.e., superiormost) thorax segmentation image. This seed point is the pixel with the lowest gray level (i.e., the lowest density pixel (LDP)) in a 60 by 60 pixel region centered over the center of mass of the thorax. In step 403 a region-growing technique [27] is performed to expand the identified trachea region about the seed point and thereby define the trachea region. As the gray level threshold is incremented by 5 during region growing, more pixels surrounding the seed point within the trachea are identified. A stopping criterion is established to halt the region growing process when the trachea has been adequately segmented. This stopping criterion is satisfied, for example, when the area of the trachea at the i^{th} iteration is less than 5 pixels greater than the corresponding area at the i-1^{th} iteration.

In step 405 the center of mass location, Cx, Cy, within the segmented trachea is determined. If the current image is the superiormost image, the process skips step 409 and returns to step 401 because step 409 compares information of two images. When the process returns to step 401, the next seed point is identified in the subsequent thorax segmentation image (i.e., the section directly below the current section). The seed point in the subsequent image is the LDP in a 15 by 20 pixel region centered over the center of mass of the trachea region in the previous image determined in step 405. Note that the region is larger in the y (vertical) direction than the x (horizontal) direction because the trachea is more likely to deviate in the y direction.

Then, in step 403 region growing is again performed to segment the trachea. Next, the center of mass, Cx, Cy, of the segmented trachea is determined in step 405.

In step 409 three conditions are checked. If any of the three conditions are satisfied, then the carina is assumed to have been reached in the current image, and bronchi segmentation begins in steps 411 and 419 (FIG. 4B). If none of the three conditions in step 409 are satisfied, then the process returns to step 401 and the seed point in the subsequent image is identified.

The first condition is checked in step 409 by comparing (A) the horizontal location of the center of mass, Cx, in the current image to (B) (1) the minimum extent of the segmented trachea in the x direction, minx, in the previous image and (2) the maximum extent of the segmented trachea in the x direction, maxx, in the previous image. If Cx<minx or if Cx>maxx, then the carina is assumed to have been reached in the current image, and bronchi segmentation begins in the current image in steps 411 and 419 (FIG. 4B).

The second condition is checked in step 409 by comparing (A) the gray level of the pixel in the current image corresponding to the center of mass of the segmented trachea in the previous image to (B) the region growing threshold used in step 403 for the previous image. If the gray level of the pixel in the current image corresponding to the center of mass in the previous image is more than 20 gray levels higher than the region growing threshold used for the previous image, then the carina is assumed to have been reached in the current image, and bronchi segmentation begins in the current image in steps 411 and 419 (FIG. 4B).

The third condition is checked by comparing the area of the segmented trachea in the current section with the area of the segmented trachea in the previous section. If the area of the trachea in the current image is less than 80% of the area of the trachea in the previous image, then the carina is assumed to have been reached in the current image, and bronchi segmentation begins in the current image in steps 411 and 419 (FIG. 4B).

Once the carina is determined to have been reached, two seed points (corresponding to the main stem bronchi) in each image are identified, and two region growing processes are performed to segment the two main bronchi in the current and subsequent images. Bronchi segmentation is not performed in images inferior to the image in which region growing first expands the “bronchi” into the lung parenchyma.

Referring to FIG. 4B, in step 411 the LDP determined in step 401 for the current image is designated as the seed point within the first main stem bronchus. Then, in step 413 region growing is performed to define the first bronchus. Region growing may be performed in the same manner as in step 403. Then, in step 415 the center of mass, C1x, C1y, is determined for the first bronchus. If the first (i.e., superiormost) bronchi image is being processed, then the process returns to step 411 and a seed point is identified for the first main stem bronchus in the subsequent bronchi image. The seed points in subsequent images are identified as the LDP in a 30 by 20 pixel search region centered over the center of mass of the segmented first main stem bronchus determined for the previous bronchi image determined in step 415. The LDP search region is wider in the x direction than the y direction because the main stem bronchi are more likely to deviate in the x direction than the y direction. Then, in step 413 region growing is performed for the new seed point determined in step 411, and in step 415 the center of mass, C1x, C1y, of the segmented bronchus is determined.

The initial seed point for the second main stem bronchus is determined by finding the LDP within a 30 by 20 pixel region centered equidistant from the carina as the initial seed point for the first main stem bronchus. Subsequent region growing and center of mass determination for the second main stem bronchus in steps 421 and 423 is preferably carried out in the same manner as steps 413 and 415, respectively. Upon completion of step 423 for the second bronchus in the superiormost bronchi image, the process returns to step 419, and the seed point for the second bronchus is identified in the subsequent bronchi image. The seed point is identified as the LDP in a 30 by 20 pixel search region centered over the center of mass, C2x, C2y, of the second bronchus in the previous image determined in step 423.

Once initial segmentation is performed for the first and second bronchi in the superiormost bronchi image, two conditions are checked in step 427 for each of the first and second bronchi, after the center of mass is computed in steps 415 and 423, respectively. If either of the conditions is satisfied, the segmentation of the corresponding bronchus is terminated in step 429. If neither of the conditions is satisfied, the process returns to step 411 or 419.

Referring to the first bronchus, in step 427 the first condition is checked by comparing (A) the vertical location of the center of mass, Cy1, in the current image to (B) (1) the minimum extent of the segmented first bronchus in the y direction, miny1, in the previous image and (2) the maximum extent of the segmented first bronchus in the y direction, maxyl, in the previous image. If Cy1<miny1 or if Cy1>maxy1, then the segmentation of the first bronchus is terminated. The same process is applied for the second bronchus, using vales of Cy2, miny2, and maxy2, which are analogous to Cy1, miny1, and miny2, respectively.

The second condition is satisfied if, during region growing for either the first or second bronchus, the number of pixels along the segmentation contour that reach the edge of the corresponding LDP search region is greater or equal to 20. If the second condition is satisfied for either bronchus, then segmentation is terminated for the corresponding bronchus.

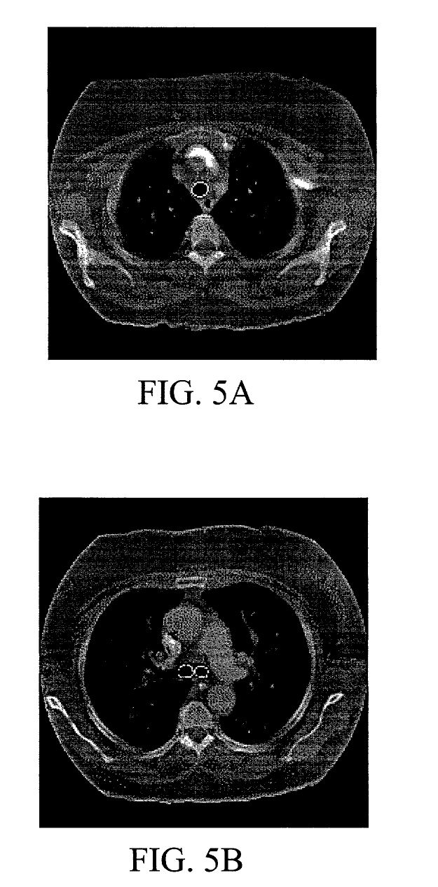

FIG. 5A is an image of the segmented trachea in a thoracic section, resulting from steps 403, 405, and 407. FIG. 5B is an image of the segmented bronchi in another section, resulting from steps 413, 415, 417, 421, 423, and 425. When applied to the above-noted 17-case database, this technique successfully eliminated the trachea and main bronchi from 98% of the segmented lung regions in which they would have otherwise been included.

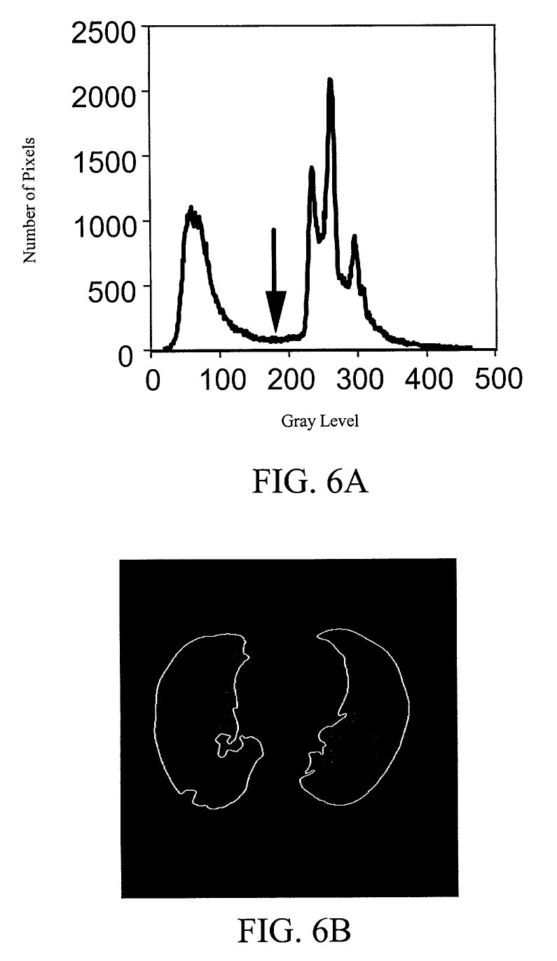

Initial lung segmentation begins for a particular section by constructing a gray level histogram from the pixels that lie within the segmented thorax region [3,28]. The distribution of pixels in this typically bimodal histogram is used to identify a single gray level as a threshold value within the broad minimum in the histogram [3]. FIG. 6A is an exemplary gray level histogram for identifying a single gray level as a threshold value. The arrow in FIG. 6A identifies the gray level value within the broad minimum in the histogram. As seen in FIG. 6B, a binary image is created by thresholding the thorax segmentation image such that a pixel is turned “on” in the binary image if the value of the corresponding pixel in the thorax segmentation image has a value less than the gray level threshold, while all other pixels remain “off” in the binary image.

The presence of a single “on” region that spans both sides of the resulting binary image indicates that gray level thresholding has “fused” the two lungs and that an anterior junction line is present in the section image. Distinction between left and right lungs is often required for segmentation results to be useful as preprocessing for more detailed image analyses. According to the present invention, the single lung region separated into two regions by eliminating pixels along the anterior junction line.

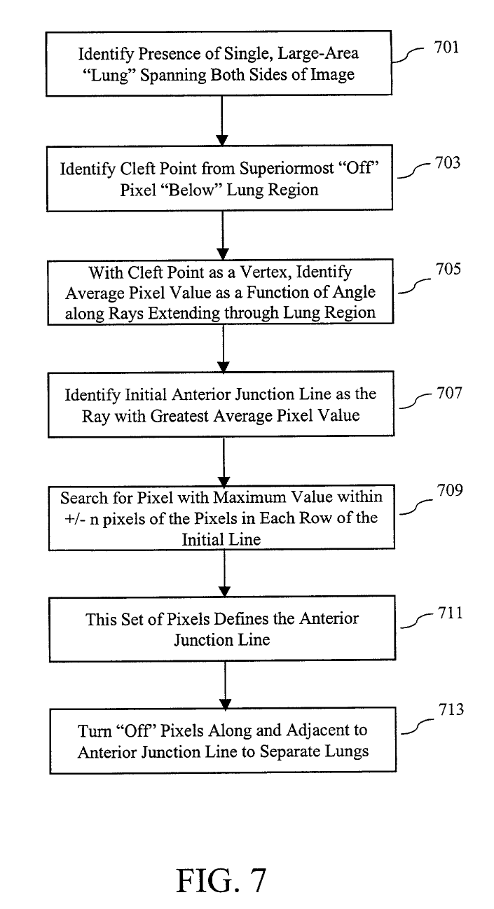

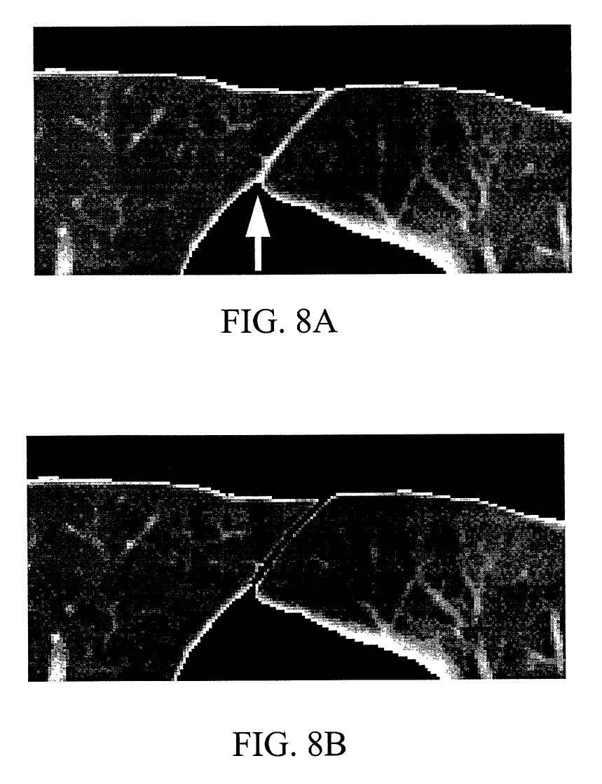

FIG. 7 is a flowchart of a process for separating a single lung region into two regions. In step 701, the presence of a single, large area lung, spanning both sides of the image is detected. The presence of a single lung are may be identified by detecting a single region of “on” pixels and/or by determining if a region of “on” pixels in a binary lung segmentation image is greater than 30% of the total area of the thorax. In step 703 a “cleft point” is identified. The cleft point is identified by searching the binary image for the most anterior point along the cardiac aspect of the lung regions. FIG. 8A is an image of a single lung region with an arrow identifying the detected cleft point. Then, in step 705 the average pixel values along rays extending through the lung region from the cleft point are determined. All the rays within +/−50 degrees of a line extending vertically from the cleft point to the upper edge of the lung region are analyzed for average pixel value. In step 707 the ray with the greatest average pixel value is identified as the initial anterior junction line.

Next, in step 705, beginning with the cleft point, the set of pixels representing the local maximum in each row extending from the cleft point toward the anterior aspect of the lung region is determined. This search is performed within +/−10 pixels of the initial anterior junction line along each row of the initial anterior junction line. These local maximum pixels are designated the anterior junction line in step 711. Then, in step 713 the local maximum pixels, along with one pixel on either side of each local maximum pixel, are turned “off” in the binary image. As a result, two distinct regions within the binary image are created, as shown in FIG. 8B. When applied to the 17-case database, this technique accurately delineated the anterior junction line in all section images in which an anterior junction line was present (100% accuracy).

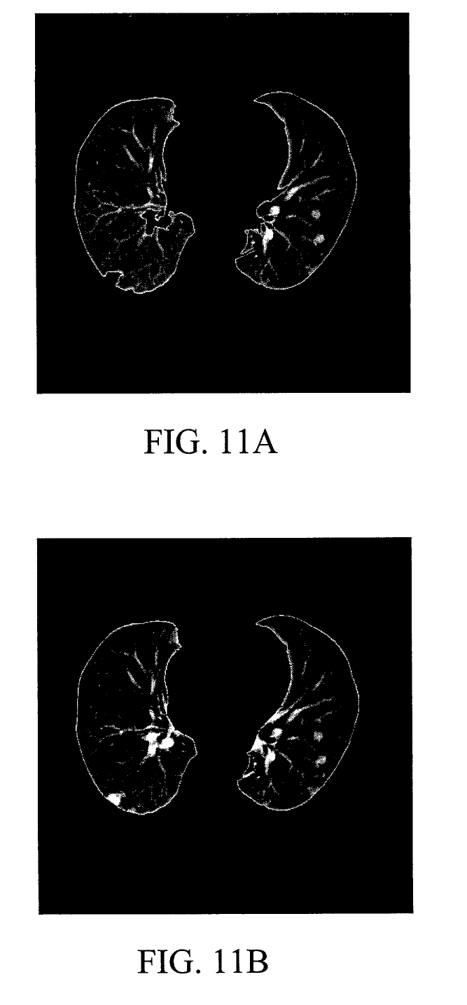

An eight-point contour detection scheme [27] is used to construct contours surrounding the outermost boundaries of the two largest “on” regions (i.e., the lungs) in the binary image in FIG. 6B. The sets of pixels in the section image that lie within these contours define the segmented lung regions and are used to create a lung segmentation image such that pixels within the segmented lung regions maintain their original value, while pixels not included within the segmented lung regions are assigned a value of 0 (FIG. 11A).

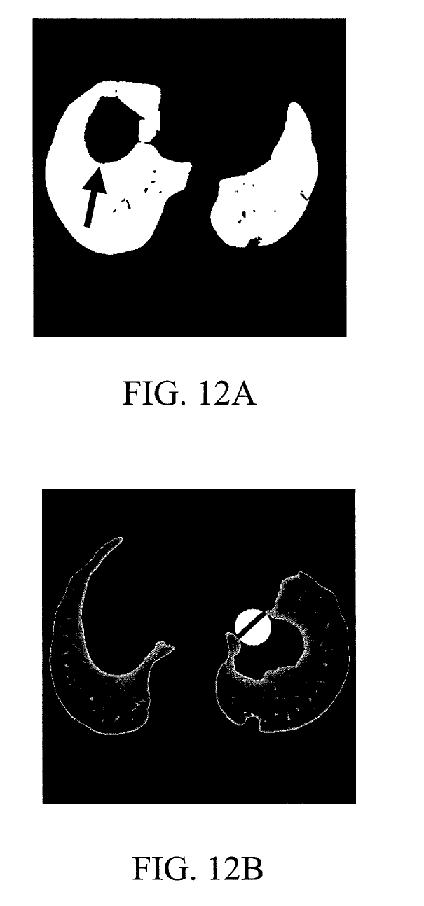

As evident from FIG. 6B, the binary images that result from gray level thresholding tend to contain “holes” of “off” pixels that are completely surrounded by “on” pixels. These holes result from denser (i.e., brighter) structures contained within the lung regions that have gray levels greater than the gray level threshold for initial lung segmentation. Consequently, the pixels corresponding to these denser structures remain “off” in the binary image. In most instances, these structures represent vessels that are part of the anatomic lungs. Since the contouring scheme considers a segmented lung region as all pixels within the outermost boundary of an “on” region in the binary image, these dense vessels are correctly included within the segmented lung regions. However, the diaphragm, which is not part of the lung, often results in a similar hole in the binary image (e.g., as shown by the arrow in FIG. 12A).

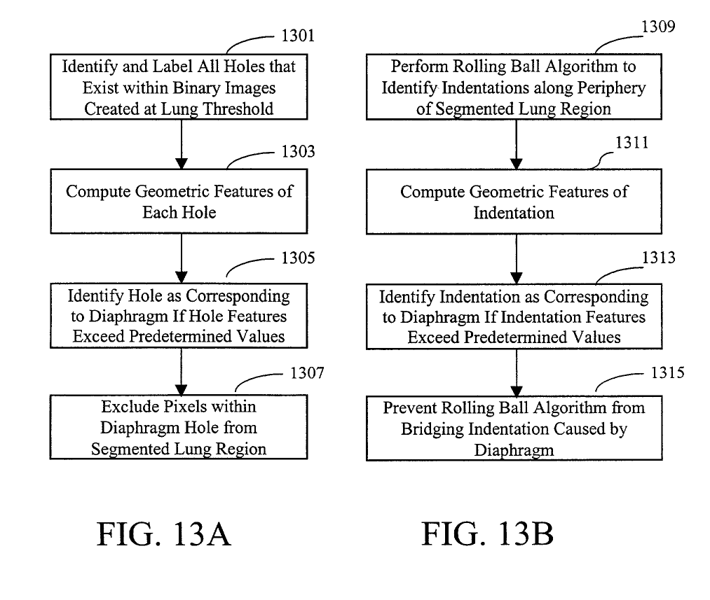

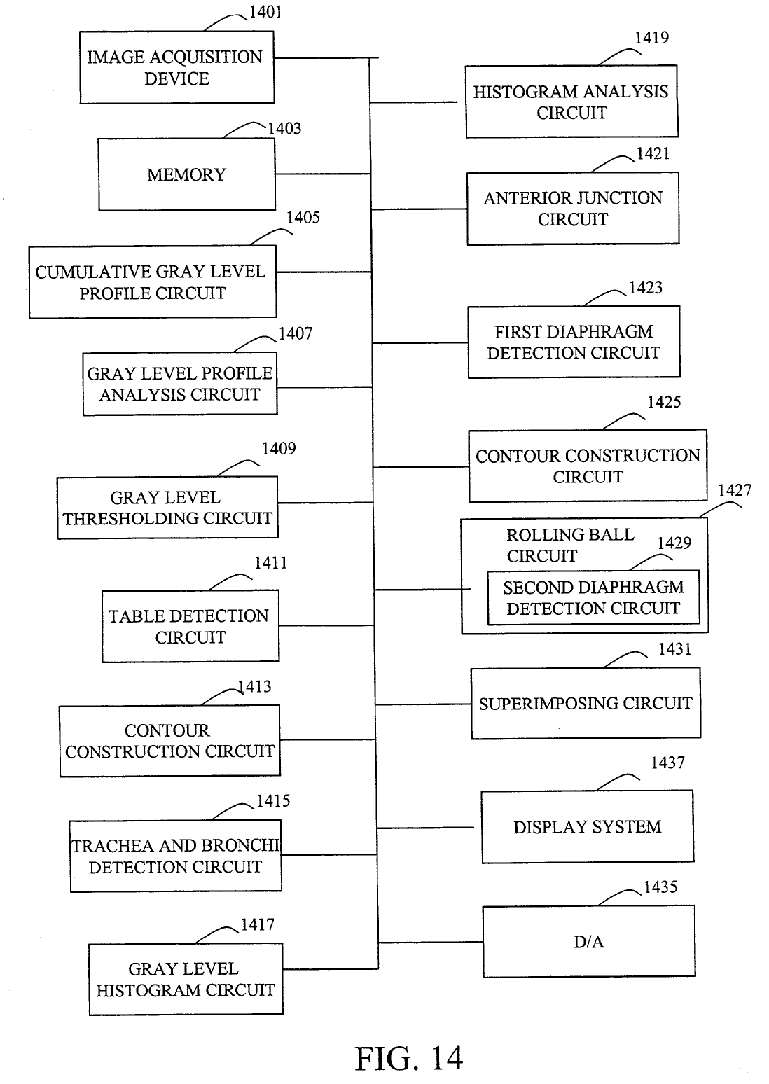

According to the present invention, each hole in a binary image is identified, and features such as area and circularity are computed in order to prevent the inclusion of pixels that belong to the diaphragm. In this manner, holes caused by the diaphragm may be identified, and the corresponding pixels may be excluded from the segmented lung regions using the processes described in FIGS. 13A and 13B, for example.

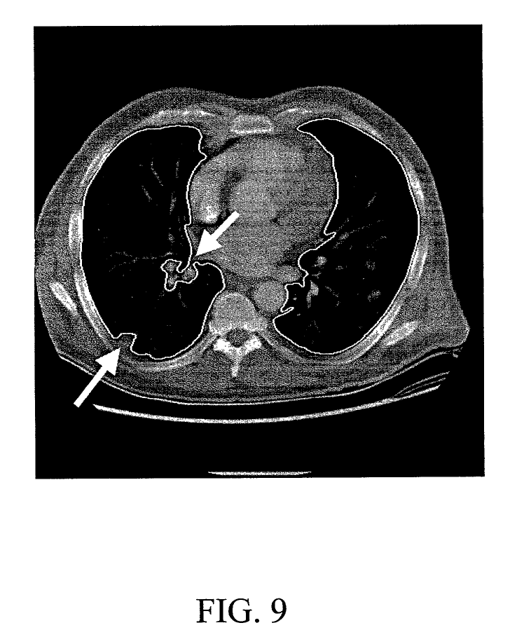

The segmented lung regions based on gray level thresholding tend to exclude dense structures along the edges of the lung regions such as juxta-pleural nodules and hilar vessels. FIG. 9 is an image of the initial lung segmentation contours with arrows identifying a juxtapleural nodule and hilar vessels.

A rolling ball algorithm is applied to properly include within the segmented lung regions dense structures along the edges of the lung regions [14,29]. A circular filter (the “ball”) is constructed and is “rolled” along the lung segmentation contours by successively identifying that pixel along the ball's circumference with a tangential slope that matches the slope of the current contour point. The filter is then positioned to align the selected ball circumference pixel with the contour pixel. If an indentation of the proper scale is encountered, the ball will overlap the contour at some contour point other than the point of contact used to place the filter. This overlap point and the point of contact define endpoints of the indentation. Linear interpolation is then used to create new contour points that connect these endpoints, effectively bridging the gap in the contour and eliminating the indentation.

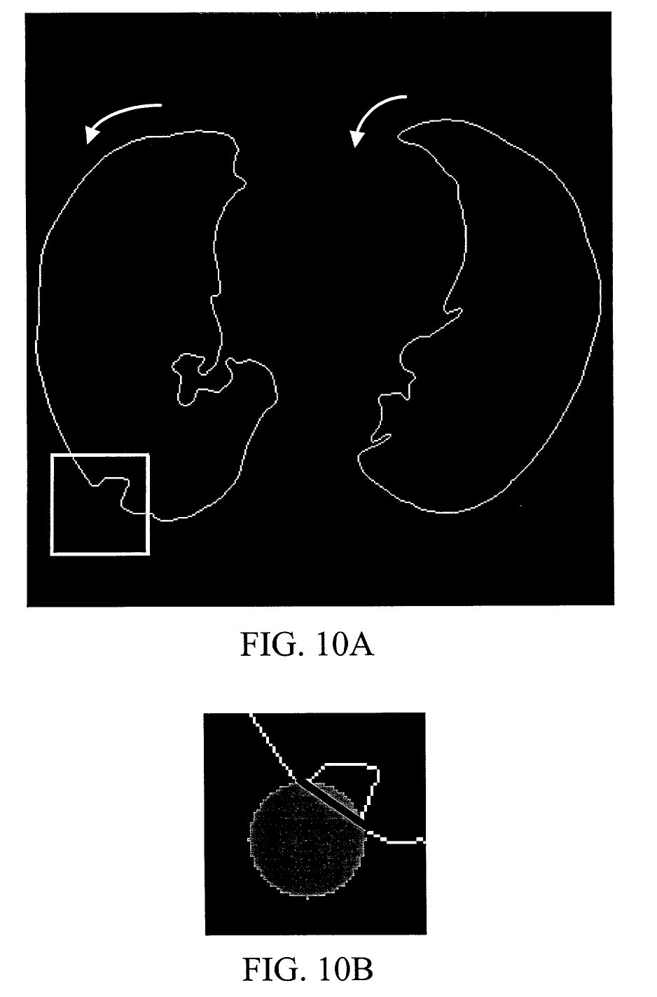

FIG. 10A is an image of two lung segmentation contours. The boxed region in Figure 10A is shown expanded in FIG. 10B with a rolling ball filter overlapping the point of contact used to place the filter and one other point (i.e., the two points of contact). The result of linear interpolation between the two points of contact is shown as a dark line connecting the two points. The newly encompassed image pixels are added to the segmented lung regions.

FIG. 11A is an image of the lung contours before application of the rolling ball filter, and FIG. 11B is an image of the lung contours after application of the rolling ball filter. An iterative, multi-scale approach is used in which balls of different radii are applied in succession to rectify indentations of different dimensions. The technique can also be applied in three-dimensions by rolling a spherical filter along the external aspect of the set of segmented lung regions from all sections (surfaces) in a case considered as a complete volume.

One potential pitfall of the rolling ball algorithm is that it may force inclusion of the diaphragm, as shown in FIG. 12B, even when the diaphragm has been properly excluded by gray level thresholding. To rectify this problem, the present invention computes geometric features of indentations identified by the rolling ball algorithm. Based on the values of these features, the rolling ball algorithm is prevented from bridging indentations caused by the diaphragm.

FIGS. 13A and 13B are flowcharts of processes for identifying pixels that belong to the diaphragm and excluding such pixels from the segmented lung regions. The process of FIG. 13A is applied in step 109 of FIG. 1. In step 1301, all holes that exist within the binary image created in step 105 are identified and labeled. In step 1303 at least one geometric feature of each hole (e.g., the area of each hole) is computed. Then, in step 1305 it is determined whether the geometric features of each hole exceed predetermined thresholds. Those holes having geometric features that exceed the predetermined values are identified as corresponding to the diaphragm. For example, if the area of the hole is greater than a predetermined threshold value of 706 mm², then the hole is identified as part of the diaphragm. Preferably, geometric feature processing is performed only on the bottom half of the images, since the diaphragm is in the lower part of the thorax. In step 1307 the pixels forming holes identified as corresponding to the diaphragm are excluded from the segmented lung region.

The process of FIG. 13B is applied during the application of the rolling ball algorithm in step 113 of FIG. 1. In step 1309 the rolling ball algorithm is performed to identify indentations along the periphery of the segmented lung region, as described above. In step 1311 at least one geometric feature of each indentation is determined. In step 1313 the geometric features of each indentation are compared against predetermined values to determine whether the geometric features of each indentation exceed predetermined values. Those indentations having geometric features that exceed the predetermined values are identified as corresponding to the diaphragm. In a preferred embodiment, the predetermined threshold value for two geometric features must be exceeded in order for an indentation to be identified as part of the diaphragm. The first feature is the number of pixels in the indentation (measured between the connecting points of the rolling ball) divided by the total number of pixels forming the entire lung contour of the corresponding lung. The threshold of the first feature is 0.20. The second feature is the compactness of the indentation. Compactness is equal to (A) the area encompassed by the indentation and the line segment connecting the two connecting points of the rolling ball divided by (B) the area of a circle having a circumference equal to the perimeter of the indentation. The perimeter of the indentation is the length of the line segment connecting the two connecting points of the rolling ball plus the length of the contour between the two connecting points.

Then, in step 1315 the rolling ball algorithm is prevented from bridging indentations corresponding to the diaphragm in order to prevent the rolling ball algorithm from including indentations corresponding to the diaphragm within the segmented lung regions.

FIG. 14 is a block diagram of a system for segmenting lung regions in thoracic CT images. The blocks in FIG. 14 correspond to program modules, circuits, and/or mechanisms configured to implement the method(s) described above. CT scans of an object are obtained from an image acquisition device 1401 and input to the system. Each image is stored in memory 1403. The image data of each section image from a particular CT scan is first passed through the cumulative gray level profile circuit 1405 and then to the gray level profile analysis circuit 1407 for gray level threshold selection. The image data along with the gray level threshold value are passed through the gray level thresholding circuit 1409 and modified by passing through the table detection circuit 1411. The data are then passed through the contour construction circuit 1413. The image data are passed through the trachea and main stem bronchi detection circuit 1415 prior to being sent through the gray level histogram circuit 1417. The output from the gray level histogram circuit are sent to the histogram analysis circuit 1419 for gray level threshold value identification. The image data along with the gray level threshold value are passed through the gray level thresholding circuit 1409 and modified by anterior junction circuit 1421. Next, the image data is passed through the first diaphragm detection circuit 1423 and then through the contour construction circuit 1425. The contours are modified through the rolling ball circuit 1427 which includes the second diaphragm detection circuit 1429. In the superimposing circuit 1431 the results are either superimposed onto images, stored in file format, and/or output in text format. The results are then displayed on the display system 1433 after passing through a digital-to-analog converter 1435.

This invention conveniently may be implemented using a conventional general purpose computer or microprocessor programmed according to the teachings of the present invention, as will be apparent to those skilled in the computer art. Appropriate software can readily be prepared by programmers of ordinary skill based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

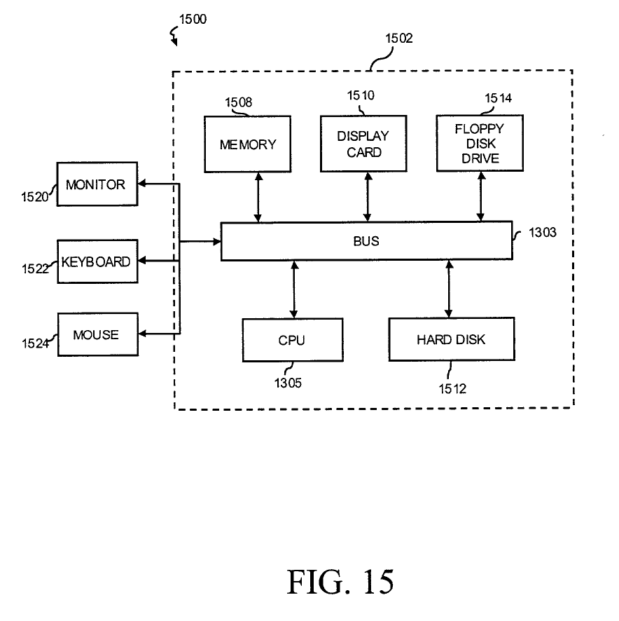

FIG. 15 is a schematic illustration of a computer system for segmenting lung regions in CT scans. A computer 1500 implements the method of the present invention, wherein the computer housing 1502 houses a CPU 1506, memory 1508 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 1500 also includes plural input devices, (e.g., a keyboard 1522 and mouse 1524), and a display card 1510 for controlling monitor 1520. In addition, the computer 1500 further includes a floppy disk drive 1514; other removable media devices (e.g., compact disc, tape, and removable magneto-optical media); and a hard disk 1512, or other fixed, high density media drives, connected using an appropriate device bus (e.g., a SCSI bus, an Enhanced IDE bus, or a Ultra DMA bus). Also connected to the same device bus or another device bus, the computer 1500 may additionally include a compact disc reader, a compact disc reader/writer unit or a compact disc jukebox.

As stated above, the system includes at least one computer readable medium. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 1500 and for enabling the computer 1500 to interact with a human user. Such software may include, but is not limited to, device drivers, operating systems and user applications, such as development tools. Such computer readable media further includes the computer program product of the present invention for performing the inventive method described above. The computer code devices of the present invention can be any interpreted or executable code mechanism, including but not limited to scripts, interpreters, dynamic link libraries, Java classes, and complete executable programs. Moreover, parts of the processing of the present invention may be distributed for better performance, reliability, and/or cost. For example, an outline or image may be selected on a first computer and sent to a second computer for remote diagnosis.

Obviously, numerous modifications and variations of the present invention are possible in light of the above teachings. For example, the outline of the nodules may be extracted using any available automated technique, rather than manually. It is therefore to be understood that within the scope of the appended claims, the invention may be practiced otherwise than as specifically described herein.

1. A method for the automated segmentation of lung regions in thoracic images, comprising:
acquiring image data representative of a cross-sectional thoracic image;
establishing a seed point within the cross-sectional thoracic image based on the image data, the seed point corresponding to a major airway;
growing the seed point to segment the major airway;
segmenting the lung regions; and
excluding the major airway from the lung regions.

2. The method of claim 1, further comprising:
determining a first pixel corresponding to a center of mass of the segmented major airway.

3. The method of claim 2, further comprising:
centering, in a subsequent cross-sectional thoracic image, a search region over a second pixel corresponding to the first pixel; and
establishing, in the subsequent cross-sectional thoracic image, another seed point at a lowest density pixel within the search region.

4. The method of claim 1, wherein the major airway is the trachea.

5. The method of claim 1, wherein the major airway is one of the first main stem bronchus and the second main stem bronchus.

6. A method for the automated segmentation of lung regions in thoracic images, comprising:
generating at least one lung contour to segment the lung regions a cross-sectional thoracic image;
identifying fusion of the lung regions;
identifying a cleft point on the lung contour;
determining the average gray level value of pixels along line segments extending from the cleft point to an upper edge of the lung regions;
identifying the anterior junction line based on the line segment with the highest average gray level value; and
extracting from the lung regions the pixels along the anterior junction line to separate the lung regions.

7. The method of claim 6, wherein the step of identifying the anterior junction line comprises:
identifying, within each row of pixels that includes a pixel of the line segment with the highest average gray level value, a pixel with the highest gray level within a predetermined distance of the line segment with the highest average gray level value; and
including within the anterior junction line the pixels identified as having the highest gray level in each row.

8. A method for the automated segmentation of lung regions in thoracic images, comprising:
acquiring image data representative of a cross-sectional thoracic image;
generating initial lung contours to segment the lung regions in the cross-sectional thoracic image;
refining the lung contours by applying a rolling ball filter to the initial lung contours to identify indentations along the initial lung contours;
determining, for each indentation identified by the rolling ball filter, whether the indentation corresponds to the diaphragm; and
preventing the rolling ball filter from including within the segmented lung regions the indentations corresponding to the diaphragm.

9. The method of claim 8, further comprising:
including within the segmented lung regions the indentations identified by the rolling ball filter that do not correspond to the diaphragm.

10. The method of claim 8, wherein the step of identifying indentations corresponding to the diaphragm comprises:
determining, for each indentation identified by the rolling ball filter, a geometric feature;
comparing the geometric feature of each indentation to a threshold; and
determining, for each indentation, whether the indentation corresponds to the diaphragm based on the comparison of the geometric feature to the threshold.

11. A method for the automated segmentation of lung regions in thoracic images, comprising:
acquiring image data representative of plural cross-sectional thoracic images;
generating initial lung contours to segment the lung regions in the plural crosssectional thoracic images; and
refining the lung contours by applying a three-dimensional rolling ball filter to the initial lung contours in the plural cross-sectional thoracic images.

12. A method for the automated segmentation of lung regions in thoracic images, comprising:
acquiring image data representative of a cross-sectional thoracic image;
generating initial lung contours to segment the lung regions in the cross-sectional thoracic image;
identifying within the lung region at least one portion corresponding to the diaphragm; and
excluding from the lung regions the at least one portion corresponding to the diaphragm.

13. The method of claim 12, wherein the step of identifying comprises:
identifying holes within the lung regions;
determining, for each hole, a geometric feature;
comparing the geometric feature of each hole with a threshold; and
determining, for each hole, whether the hole corresponds to the diaphragm based on the comparison of the geometric feature to the threshold;
wherein the excluding step comprises:
excluding from the lung regions the holes corresponding to the diaphragm.

14. The method of claim 12, further comprising:
identifying an anterior junction line and extracting from the lung regions pixels along the anterior junction line to separate the lung regions.

15. The method of claim 12, further comprising:
identifying within the lung regions portions corresponding to the trachea and main stem bronchi; and
excluding from the lung regions the portions corresponding to the trachea and the main stem bronchi.

16. The method of claim 15, further comprising:
refining the lung contours by applying a rolling ball filter to the lung contours to identify indentations along the lung contours;
determining, for each indentation identified by the rolling ball filter, whether the indentation corresponds to the diaphragm; and
preventing the rolling ball filter from including within the segmented lung regions the indentations corresponding to the diaphragm.

17. The method of claim 16, wherein the step of refining the lung contours by applying a rolling ball filter comprises:
applying a three-dimensional rolling ball filter to the lung contours in the crosssectional thoracic image and to other lung contours in other cross-sectional thoracic images.

18. A system for the automated segmentation of lung regions in thoracic images, comprising:
a mechanism configured to acquire image data representative of a cross-sectional thoracic image;
a mechanism configured to establish a seed point within the cross-sectional thoracic image based on the image data, the seed point corresponding to a major airway;
a mechanism configured to grow the seed point to segment the major airway;
a mechanism configured to segment the lung regions; and
a mechanism configured to exclude the major airway from the lung regions.

19. The system of claim 18, further comprising:
a mechanism configured to determine a first pixel corresponding to a center of mass of the segmented major airway.

20. The system of claim 19, further comprising:
a mechanism configured to center, in a subsequent cross-sectional thoracic image, a search region over a second pixel corresponding to the first pixel; and
a mechanism configured to establish, in the subsequent cross-sectional thoracic image, another seed point at a lowest density pixel within the search region.

21. The system of claim 18, wherein the major airway is the trachea.

22. The system of claim 18, wherein the major airway is one of the first main stem bronchus and the second main stem bronchus.

23. A system for the automated segmentation of lung regions in thoracic images, comprising:
a mechanism configured to generate at least one lung contour to segment the lung regions a cross-sectional thoracic image;
a mechanism configured to identify fusion of the lung regions;
a mechanism configured to identify a cleft point on the lung contour;
a mechanism configured to determine the average gray level value of pixels along line segments extending from the cleft point to an upper edge of the lung regions;
a mechanism configured to identify the anterior junction line based on the line segment with the highest average gray level value; and
a mechanism configured to extract from the lung regions the pixels along the anterior junction line to separate the lung regions.

24. The system of claim 23, wherein the mechanism configured to identify the anterior junction line comprises:
a mechanism configured to identify, within each row of pixels that includes a pixel of the line segment with the highest average gray level value, a pixel with the highest gray level within a predetermined distance of the line segment with the highest average gray level value; and
a mechanism configured to include within the anterior junction line the pixels identified as having the highest gray level in each row.

25. A system for the automated segmentation of lung regions in thoracic images, comprising:
a mechanism configured to acquire image data representative of a cross-sectional thoracic image;
a mechanism configured to generate initial lung contours to segment the lung regions in the cross-sectional thoracic image;
a mechanism configured to refine the lung contours by applying a rolling ball filter to the initial lung contours to identify indentations along the initial lung contours;
a mechanism configured to determine, for each indentation identified by the rolling ball filter, whether the indentation corresponds to the diaphragm; and
a mechanism configured to prevent the rolling ball filter from including within the segmented lung regions the indentations corresponding to the diaphragm.

26. The system of claim 25, further comprising:
a mechanism configured to include within the segmented lung regions the indentations identified by the rolling ball filter that do not correspond to the diaphragm.

27. The system of claim 25, wherein the mechanism configured to identify indentations corresponding to the diaphragm comprises:
a mechanism configured to determine, for each indentation identified by the rolling ball filter, a geometric feature;
a mechanism configured to compare the geometric feature of each indentation to a threshold; and
a mechanism configured to determine, for each indentation, whether the indentation corresponds to the diaphragm based on the comparison of the geometric feature to the threshold.

28. A system for the automated segmentation of lung regions in thoracic images, comprising:
a mechanism configured to acquire image data representative of plural cross-sectional thoracic images;
a mechanism configured to generate initial lung contours to segment the lung regions in the plural cross-sectional thoracic images; and
a mechanism configured to refine the lung contours by applying a three-dimensional rolling ball filter to the initial lung contours in the plural cross-sectional thoracic images.

29. A system for the automated segmentation of lung regions in thoracic images, comprising:
a mechanism configured to acquire image data representative of a cross-sectional thoracic image;
a mechanism configured to generate initial lung contours to segment the lung regions in the cross-sectional thoracic image;
a mechanism configured to identify within the lung region at least one portion corresponding to the diaphragm; and
a mechanism configured to exclude from the lung regions the at least one portion corresponding to the diaphragm.

30. The system of claim 29, wherein the mechanism configured to identify comprises:
a mechanism configured to identify holes within the lung regions;
a mechanism configured to determine, for each hole, a geometric feature;
a mechanism configured to compare the geometric feature of each hole with a threshold; and
a mechanism configured to determine, for each hole, whether the hole corresponds to the diaphragm based on the comparison of the geometric feature to the threshold;
wherein the mechanism configured to exclude comprises:
a mechanism configured to exclude from the lung regions the holes corresponding to the diaphragm.

31. The system of claim 29, further comprising:
a mechanism configured to identify an anterior junction line and extracting from the lung regions pixels along the anterior junction line to separate the lung regions.

32. The system of claim 29, further comprising:
a mechanism configured to identify within the lung regions portions corresponding to the trachea and main stem bronchi; and
a mechanism configured to exclude from the lung regions the portions corresponding to the trachea and the main stem bronchi.

33. The system of claim 32, further comprising:
a mechanism configured to refine the lung contours by applying a rolling ball filter to the lung contours to identify indentations along the lung contours;
a mechanism configured to determine, for each indentation identified by the rolling ball filter, whether the indentation corresponds to the diaphragm; and
a mechanism configured to prevent the rolling ball filter from including within the segmented lung regions the indentations corresponding to the diaphragm.

34. The system of claim 33, wherein the mechanism configured to refine the lung contours by applying a rolling ball filter comprises:
a mechanism configured to apply a three-dimensional rolling ball filter to the lung contours in the cross-sectional thoracic image and to other lung contours in other crosssectional thoracic images.

35. A computer readable medium storing computer instructions for the automated segmentation of lung regions in thoracic images, by performing the steps of:
acquiring image data representative of a cross-sectional thoracic image;
establishing a seed point within the cross-sectional thoracic image based on the image data, the seed point corresponding to a major airway;
growing the seed point to segment the major airway;
segmenting the lung regions; and
excluding the major airway from the lung regions.

36. The computer readable medium of claim 35, storing further instructions for performing the step of:
determining a first pixel corresponding to a center of mass of the segmented major airway.

37. The computer readable medium of claim 36, storing further instructions for performing the steps of:
centering, in a subsequent cross-sectional thoracic image, a search region over a second pixel corresponding to the first pixel; and
establishing, in the subsequent cross-sectional thoracic image, another seed point at a lowest density pixel within the search region.

38. The computer readable medium of claim 35, wherein the major airway is the trachea.

39. The computer readable medium of claim 35, wherein the major airway is one of the first main stem bronchus and the second main stem bronchus.

40. A computer readable medium storing computer instructions for the automated segmentation of lung regions in thoracic images, by performing the steps of:
generating at least one lung contour to segment the lung regions a cross-sectional thoracic image;
identifying fusion of the lung regions;
identifying a cleft point on the lung contour;
determining the average gray level value of pixels along line segments extending from the cleft point to an upper edge of the lung regions;
identifying the anterior junction line based on the line segment with the highest average gray level value; and
extracting from the lung regions the pixels along the anterior junction line to separate the lung regions.

41. The computer readable medium of claim 40, wherein the step of identifying the anterior junction line comprises:
identifying, within each row of pixels that includes a pixel of the line segment with the highest average gray level value, a pixel with the highest gray level within a predetermined distance of the line segment with the highest average gray level value; and
including within the anterior junction line the pixels identified as having the highest gray level in each row.

42. A computer readable medium storing computer instructions for the automated segmentation of lung regions in thoracic images, by performing the steps of:
acquiring image data representative of a cross-sectional thoracic image;
generating initial lung contours to segment the lung regions in the cross-sectional thoracic image;
refining the lung contours by applying a rolling ball filter to the initial lung contours to identify indentations along the initial lung contours;
determining, for each indentation identified by the rolling ball filter, whether the indentation corresponds to the diaphragm; and
preventing the rolling ball filter from including within the segmented lung regions the indentations corresponding to the diaphragm.

43. The computer readable medium of claim 42, storing further instructions for performing the step of:
including within the segmented lung regions the indentations identified by the rolling ball filter that do not correspond to the diaphragm.

44. The computer readable medium of claim 42, wherein the step of identifying indentations corresponding to the diaphragm comprises:
determining, for each indentation identified by the rolling ball filter, a geometric feature;
comparing the geometric feature of each indentation to a threshold; and
determining, for each indentation, whether the indentation corresponds to the diaphragm based on the comparison of the geometric feature to the threshold.

45. A computer readable medium storing computer instructions for the automated segmentation of lung regions in thoracic images, by performing the steps of:
acquiring image data representative of plural cross-sectional thoracic images;
generating initial lung contours to segment the lung regions in the plural crosssectional thoracic images; and
refining the lung contours by applying a three-dimensional rolling ball filter to the initial lung contours in the plural cross-sectional thoracic images.

46. A computer readable medium storing computer instructions for the automated segmentation of lung regions in thoracic images, by performing the steps of:
acquiring image data representative of a cross-sectional thoracic image;
generating initial lung contours to segment the lung regions in the cross-sectional thoracic image;
identifying within the lung region at least one portion corresponding to the diaphragm; and
excluding from the lung regions the at least one portion corresponding to the diaphragm.

47. The computer readable medium of claim 46, wherein the step of identifying comprises:
identifying holes within the lung regions;
determining, for each hole, a geometric feature;
comparing the geometric feature of each hole with a threshold; and
determining, for each hole, whether the hole corresponds to the diaphragm based on the comparison of the geometric feature to the threshold;
wherein the excluding step comprises:
excluding from the lung regions the holes corresponding to the diaphragm.

48. The computer readable medium of claim 46, storing further instructions for performing the step of:
identifying an anterior junction line and extracting from the lung regions pixels along the anterior junction line to separate the lung regions.

49. The computer readable medium of claim 46, storing further instructions for performing the steps of:
identifying within the lung regions portions corresponding to the trachea and main stem bronchi; and
excluding from the lung regions the portions corresponding to the trachea and the main stem bronchi.

50. The computer readable medium of claim 49, storing further instructions for performing the steps of:
refining the lung contours by applying a rolling ball filter to the lung contours to identify indentations along the lung contours;
determining, for each indentation identified by the rolling ball filter, whether the indentation corresponds to the diaphragm; and
preventing the rolling ball filter from including within the segmented lung regions the indentations corresponding to the diaphragm.

51. The computer readable medium of claim 50, wherein the step of refining the lung contours by applying a rolling ball filter comprises:
applying a three-dimensional rolling ball filter to the lung contours in the crosssectional thoracic image and to other lung contours in other cross-sectional thoracic images.
